(19) United States
(12) Patent Application Publication
(10) Pub. No.: US 2025/0358510 A1
(43) Pub. Date: Nov. 20, 2025

(54) AUTOFOCUS IMAGING DEVICE

(71) Applicant: SK hynix Inc., Icheon-si (KR)

(72) Inventors: Tatsuro KOIZUMI, Tokyo (JP); Sung Kyu LEE, Tokyo (JP)

(21) Appl. No.: 19/209,548

(22) Filed: May 15, 2025

(30) Foreign Application Priority Data
May 17, 2024 (KR) 10-2024-0064544

(51) Int. Cl. H04N 23/67; G02B 7/30; H04N 25/76

(52) U.S. Cl. CPC H04N 23/672; G02B 7/30; H04N 25/7795

(57) ABSTRACT

An imaging device includes an evaluation value calculator configured to calculate an evaluation value set including evaluation values corresponding to candidate parallaxes based on a phase image set, and a parallax calculator configured to calculate a target parallax based on the evaluation value set, the target parallax representing a phase shift value that allows to minimize a difference between phase images corresponding to phase signals with respect to an object to be imaged. Each of the evaluation values indicates a degree of certainty that the candidate parallax corresponding to each evaluation value is the target parallax.

### PRIORITY AND CROSS-REFERENCE TO RELATED APPLICATION

This patent document claims the priority and benefits of Korean patent application No. 10-2024-0064544, filed on May 17, 2024, the disclosure of which is incorporated herein by reference in its entirety as part of the disclosure of this patent document.

### TECHNICAL FIELD

The technology and implementations disclosed in this patent document generally relate to an imaging device for performing an autofocus function.

### BACKGROUND

An imaging device is a device including an imaging circuit that captures optical images by converting light into electrical signals using a photosensitive semiconductor material which reacts to light. With the development of automotive, medical, computer and communication industries, the demand for high-performance imaging devices is increasing in various fields such as smart phones, digital cameras, game machines, IoT (Internet of Things), robots, security cameras and medical micro cameras.

The imaging devices may be roughly divided into CCD (Charge Coupled Device) imaging circuits and CMOS (Complementary Metal Oxide Semiconductor) imaging circuits. The CCD imaging circuits offer a better image quality, but they tend to consume more power and are larger as compared to the CMOS imaging circuits.

The CMOS imaging circuits are smaller in size and consume less power than the CCD imaging circuits. Furthermore, CMOS imaging circuits are fabricated using the CMOS fabrication technology, and thus photosensitive elements and other signal processing circuitry can be integrated into a single chip, enabling the production of miniaturized imaging circuits at a lower cost.

### SUMMARY

Various embodiments of the present disclosure relate to an imaging device for providing a phase-difference autofocus (PDAF) function that reduces the influence of noise, and a method for operating the same.

In accordance with an embodiment of the present disclosure, an imaging device may include an evaluation value calculator configured to calculate an evaluation value set including evaluation values corresponding to candidate parallaxes based on a phase image set; and a parallax calculator configured to calculate a target parallax based on the evaluation value set, the target parallax representing a phase shift value that allows to minimize a difference between phase images corresponding to phase signals with respect to an object to be imaged. Each of the evaluation values indicates a degree of certainty that the candidate parallax corresponding to each evaluation value is the target parallax.

In some implementations, the imaging device may further include: an imaging circuit that includes a lens and is configured to collect a phase signal pair including a first phase signal for an object and a second phase signal for the object, wherein the phase image set includes a first phase image corresponding to the first phase signal and a second phase image corresponding to the second phase signal.

In some implementations, the target parallax controls an in-focus position of the lens so that the first phase image and the second phase image coincide with each other.

In some implementations, the evaluation value calculator may be configured to calculate the evaluation value set based on a sum of absolute differences (SAD) between the first phase image and the second phase image.

In some implementations, the evaluation value calculator may be configured to calculate the evaluation value set based on a sum of square differences (SSD) between the first phase image and the second phase image.

In some implementations, the evaluation value calculator may be configured to calculate the evaluation value set based on phase correlation between the first phase image and the second phase image.

In some implementations, the evaluation value calculator may be configured to calculate the evaluation value set based on cross-correlation between the first phase image and the second phase image.

In some implementations, the imaging device may further include: an image generator configured to generate the phase image set based on the phase signal pair.

In some implementations, the image generator may be configured to generate a plurality of time phase image sets based on a plurality of phase signal pairs collected at different times; the evaluation value calculator may be further configured to calculate a plurality of time evaluation value sets respectively corresponding to the plurality of time phase image sets; and the parallax calculator may be further configured to calculate the target parallax based on the plurality of time evaluation value sets.

In some implementations, the image generator may be further configured to generate a plurality of region phase image sets based on one phase signal pair collected at an arbitrary time; the evaluation value calculator may be further configured to calculate a plurality of region evaluation value sets corresponding to the plurality of region phase image sets; and the parallax calculator may be configured to calculate the target parallax based on the plurality of region evaluation value sets.

In some implementations, the imaging circuit may be configured to transmit the phase signal pair to the image generator at preset time intervals; and the image generator may be configured to generate the phase image set at the preset time intervals.

In some implementations, upon receiving new phase image sets, the evaluation value calculator may be configured to discard evaluation value sets calculated based on previously received phase image sets.

In some implementations, the parallax calculator may calculate a sum of evaluation values that are respectively included in different evaluation value sets and correspond to an arbitrary candidate parallax, and may calculate a candidate parallax with the largest sum of evaluation values as the target parallax.

In some implementations, the evaluation value calculator may be configured to convert a plurality of evaluation value sets corresponding to a plurality of phase image sets into evaluation value sets corresponding to a current in-focus position of a lens included in the imaging device; and the parallax calculator may be configured to calculate the target parallax based on evaluation value sets corresponding to the current in-focus position of the lens.

In some implementations, the evaluation value calculator may be configured to calculate reliability for the evaluation value set based on noise of the phase image set; and the parallax calculator may be configured to calculate the target parallax based on the reliability.

In some implementations, the parallax calculator may be configured to calculate the target parallax based on candidate parallaxes respectively corresponding to maximum evaluation values included in different evaluation value sets.

In another aspect, an imaging device may include an imaging circuit that includes a lens and configured to collect a plurality of phase signal pairs for an object; an image generator configured to generate a plurality of phase image sets based on the plurality of phase signal pairs; an evaluation value calculator configured to calculate a plurality of evaluation value sets including evaluation values corresponding to candidate parallaxes, based on the plurality of phase image sets; and a parallax calculator configured to calculate a target parallax based on the plurality of evaluation value sets, the target parallax representing a phase shift value that allows to minimize a difference between phase images corresponding to the plurality of phase signal pairs, wherein the target parallax is a parallax that controls an in-focus position of the lens with respect to the object.

In some implementations, each of the evaluation values may indicate a degree of certainty that the candidate parallax corresponding to each evaluation value is the target parallax.

In some implementations, the plurality of phase signal pairs may be collected at different times.

In some implementations, the plurality of phase signal pairs may be collected at the same time.

It is to be understood that both the foregoing general description and the following detailed description of the present disclosure are illustrative and explanatory and are intended to provide further explanation of the disclosure as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a diagram illustrating a structure of an imaging device based on some implementations of the disclosed technology.

FIG. 2 is a block diagram illustrating an example of an image processor based on some implementations of the disclosed technology.

FIGS. 3A to 3C are diagrams illustrating examples of a method for calculating a target parallax based on a plurality of phase signal pairs collected at different times based on some implementations of the disclosed technology.

FIGS. 4A to 4C are diagrams illustrating examples of a method for calculating a target parallax based on a single image collected at arbitrary times based on some implementations of the disclosed technology.

### DETAILED DESCRIPTION

This patent document provides implementations and examples of an imaging device for performing an autofocus function that may be used in configurations to substantially address one or more technical or engineering issues and to mitigate limitations or disadvantages encountered in some other imaging devices. Some implementations of the present disclosure relate to an imaging device for providing a phase-difference autofocus (PDAF) function that reduces the influence of noise, and a method for operating the same.

The imaging device may perform an autofocus (AF) function based on signals collected from the imaging circuit. In various implementations, the imaging device may use a phase-based autofocus function or a contrast-based autofocus function. The imaging device that performs phase-based autofocus can determine the direction and amount of positional movement of a lens based on a single frame captured through the imaging circuit. Therefore, phase-based autofocus may increase the focusing speed compared to contrast-based autofocus. However, if the captured signal includes noise, distortion of a phase image may occur, and accurate focusing may become difficult as autofocus is performed based on the distorted image.

In recognition of the issues above, the disclosed technology may provide the imaging device with an image processor that can more accurately calculate a target parallax by reducing the influence of noise. The disclosed technology may provide the image processor that can calculate an evaluation-value set including evaluation values for each of candidate parallaxes expected to be the target parallax, and may calculate the target parallax based on the calculated evaluation-value set.

Reference will now be made in detail to the embodiments of the present disclosure, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

In the following description, a detailed description of related known configurations or functions incorporated herein will be omitted to avoid obscuring the subject matter.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprises”, “includes”, “including”, and/or “comprising,” when used in this specification, specify the presence of stated constituent elements, steps, operations, and/or components, but do not preclude the presence or addition of one or more other constituent elements, steps, operations, and/or components thereof. The term “and/or” may include a combination of a plurality of items or any one of a plurality of items.

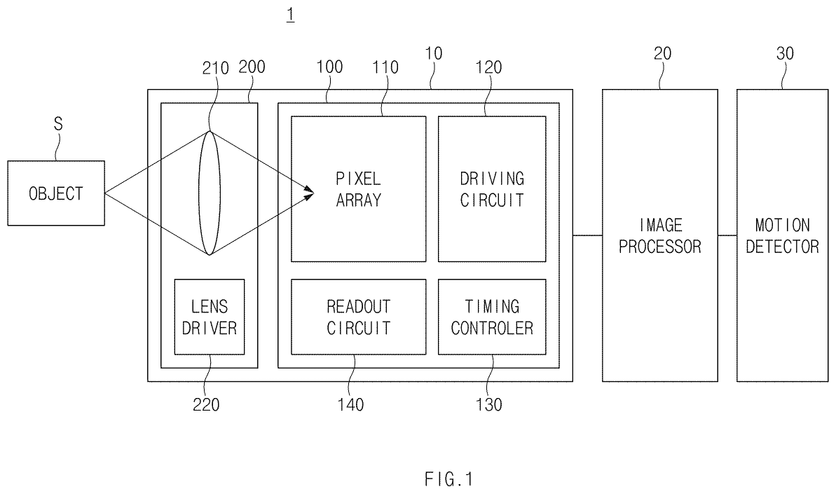

FIG. 1 is a diagram illustrating an example structure of an imaging device 1 according to embodiments of the present disclosure. A method of performing an autofocus (AF) function by the imaging device 1 will hereinafter be described with reference to FIG. 1.

Referring to FIG. 1, the imaging device 1 may include an imaging circuit 10, an image processor 20, and a motion detector 30.

The imaging circuit 10 may include an image sensor 100 and a lens module 200. The image sensor 100 may include a pixel array 110, a driving circuit 120, a timing controller 130, and a readout circuit 140.

In some implementations, the pixel array 110 may include a plurality of unit pixels.

Upon receiving incident light (e.g., optical signal) that has passed through the lens 210 included in the lens module 200, a unit pixel included in the pixel array 110 may generate pixel signals corresponding to the incident light and the pixel signals may be converted into an electrical signal. Unit pixels may respectively generate electrical signals (e.g., pixel signals) corresponding to an external object(S).

Each unit pixel included in the pixel array 110 may include a photoelectric conversion element that absorbs light to generate charges. The pixel signals generated by the unit pixels may correspond to charges generated by each photoelectric conversion element and the unit pixels may provide the pixel signals to the readout circuit 140.

In some implementations, at least some of the unit pixels included in the pixel array 110 may be phase-difference pixels that generate different phase signals for the same object.

A pair of phase-difference pixels may be arranged adjacently in a vertical direction, a horizontal direction, or a diagonal direction in the pixel array to generate different phase signals for the same object. At this time, one of two phase-difference pixels corresponding to one pair of phase-difference pixels that generate different phase signals may be referred to as a first phase signal collector, and the other one of the two phase-difference pixels may be referred to as a second phase signal collector.

In addition, a signal generated by the first phase signal collector may be referred to as a first phase signal, and a signal generated by the second phase signal collector may be referred to as a second phase signal.

In some other implementations, the phase-difference pixels may include two photoelectric conversion elements that are adjacent to each other in a vertical or horizontal direction so as to generate different phase signals.

One pair of photoelectric conversion elements that generate different phase signals and are included in one phase-difference pixel may be referred to as a phase signal collector. At this time, one of two photoelectric conversion elements corresponding to one pair of photoelectric conversion elements that generate different phase signals may be referred to as a first phase signal collector, and the other one of the two photoelectric conversion elements may be referred to as a second phase signal collector. Additionally, a signal generated by the first phase signal collector may be referred to as a first phase signal, and a signal generated by the second phase signal collector may be referred to as a second phase signal.

Each of the unit pixels included in the pixel array 110 may include a microlens, an optical filter, a photoelectric conversion element, and an interconnect layer (also called a wiring layer). In some implementations, one unit pixel may overlap one microlens.

The microlens may allow light incident upon the pixel array 110 to converge upon the optical filter and the photoelectric conversion element. The optical filter may enable the incident light having penetrated the microlens to selectively pass therethrough based on wavelengths of the incident light.

Each unit pixel may include a photoelectric conversion element that receives incident light. The photoelectric conversion element may generate photocharges corresponding to incident light that has penetrated the microlens and the optical filter. Each of the photoelectric conversion elements may be implemented as a photodiode, a phototransistor, a photogate, a pinned photodiode (PPD), or a combination thereof. In the following descriptions, it is assumed that each photoelectric conversion element is implemented as a photodiode as an example.

If the photoelectric conversion element is a photodiode, the photoelectric conversion element may include a stacked structure in which an N-type impurity region and a P-type impurity region are vertically stacked. The photoelectric conversion element may be formed in a semiconductor substrate. For example, the semiconductor substrate may be a P-type semiconductor substrate.

The interconnect layer may be disposed below the photoelectric conversion element. Here, the interconnect layer may also be called a wiring layer as needed. The interconnect layer may include a reset transistor, a transfer transistor, a floating diffusion (FD) region, a drive transistor, a selection transistor, etc.

The reset transistor may be activated in response to a reset control signal, such that the reset transistor may reset the potential of each unit pixel to a predetermined voltage level (e.g., a pixel voltage level).

In addition, when the reset transistor is activated, the transfer transistor may also be activated to reset the floating diffusion (FD) region.

Since the transfer transistor is activated in response to a transmission (Tx) control signal, the transfer transistor can transmit photocharges accumulated in the photoelectric conversion element of each pixel to the floating diffusion (FD) region.

In some implementations, each unit pixel may include a transfer transistor corresponding to each photoelectric conversion element.

The floating diffusion (FD) region may receive photocharges generated by the photoelectric conversion element. The floating diffusion (FD) region may be connected to a gate electrode of the drive transistor.

The drive transistor may receive a pixel voltage through a drain electrode thereof, and may be coupled to the floating diffusion (FD) region through a gate electrode thereof. In addition, the drive transistor may be coupled to the selection transistor through a source electrode thereof.

The drive transistor may output a current corresponding to the voltage of the floating diffusion (FD) region coupled to a gate electrode thereof to a signal line through the selection transistor. In other words, the voltage of the floating diffusion (FD) region can be amplified through the drive transistor.

The selection transistor may be activated in response to a selection control signal applied to a gate electrode thereof, such that the selection transistor may transmit an output signal of the drive transistor to a signal line. The electrical signals applied to the signal line may be provided to the readout circuit 140.

The pixel signal may be a signal output in response to photocharges accumulated in the floating diffusion (FD) region included in the pixel array 110.

The readout circuit 140 may include a correlated double sampler (CDS), an analog-to-digital converter (ADC), a buffer, and the like.

The correlated double sampler (CDS) may sample and hold pixel signals received from the pixel array 110. The correlated double sampler (CDS) may perform double sampling of a pixel signal level caused by incident light and a specific noise level, and may thus output a signal level corresponding to a difference between the sampling resultant signals. Noise in the pixel signal may be removed by the correlated double sampler (CDS).

The analog-to-digital converter (ADC) may convert the analog signals received from the CDS into digital signals, and may transmit the digital signals to the buffer.

The buffer may latch the received digital signals, and may sequentially output the latched digital signals to the image processor 20. The buffer may include a memory for latching the digital signals and a sense amplifier for amplifying the digital signals.

The driving circuit 120 may drive the plurality of unit pixels contained in the pixel array 110 in response to an output signal of the timing controller 130.

For example, the driving circuit 120 may generate signals (e.g., a transfer control signal for controlling the transfer transistor, a reset control signal for controlling the reset transistor, a selection control signal for controlling the selection transistor, etc.) to control transistors contained in the plurality of unit pixels included in the pixel array 110, and may provide the generated signals to the pixel array 110.

The driving circuit 120 may determine activation and deactivation timing points of the transfer control signal, the reset control signal, and the selection control signal that are provided to the unit pixels.

The timing controller 130 may control the driving circuit 120 to allow the pixel array 110 to absorb light and accumulate photocharges, may enable the pixel array 110 to temporarily store the accumulated photocharges, and may output electrical signals caused by the stored photocharges to the outside of the pixel array 110.

The pixel signal may correspond to photocharges generated by a photoelectric conversion element included in the pixel array 110.

The timing controller 130 may control the readout circuit 140 to sample and hold pixel signals received from the pixel array 110. The timing controller 130 may control the analog-to-digital converter (ADC) to convert the signal received from the CDS into a digital signal.

The timing controller 130 may generate/store a control signal for controlling the readout circuit 140 based on the signal received from the image processor 20.

In some implementations, the pixel signals corresponding to photocharges generated by each of one pair of phase signal collectors may be referred to as phase signals. Phase signals corresponding to one pair of phase signal collectors may be referred to as a phase signal pair.

The imaging circuit 10 may provide a phase signal pair to the image processor 20. The image processor 20 may generate a set of phase images (hereinafter referred to as a phase image set) based on the received phase signal pair. The phase signal pair includes the first phase signal for the object and the second phase signal for the object. The first phase signal is generated by the first phase signal collector and the second phase signal is generated by the second phase signal collector. The phase image set includes a first phase image corresponding to the first phase signal and a second phase image corresponding to the second phase signal.

The lens module 200 may be a component that receives light. Specifically, the lens module 200 may include a lens 210 and a lens driver 220.

The lens 210 may be implemented as a single lens. In some implementations, a plurality of lenses may be included in the lens module 200.

The lens driver 220 may control (focus) the position of the lens 210 based on a control signal from the image processor 20. As the position of the lens 210 is adjusted, the in-focus position between the lens 210 and the target object(S) may be adjusted.

The image processor 20 may receive a phase signal pair (e.g., a first phase signal and a second phase signal) generated by the pair of phase-difference pixels included in the pixel array 110 of the imaging circuit 10 and generate a phase image set including a first phase image and a second phase image based on the phase signal pair output from the imaging circuit 10. The image processor 20 may calculate a target parallax for autofocusing based on the generated phase image set.

The target parallax may mean a parallax calculated from the first phase image and the second phase image when there is no influence of noise on the first phase image and the second phase image included in the phase image set.

The image processor 20 may generate a control signal for the lens driver 220 using the calculated target parallax and provide the generated control signal to the lens driver 220.

The lens driver 220 may control the in-focus position of the lens 210 so that the target object(S) is in focus according to the control signal.

The image processor 20 may calculate evaluation values corresponding to candidate parallaxes based on the first phase image and the second phase image that are included in the phase image set.

The parallax may mean a difference between two phase images (one pair of phase images) for a single external object(S).

The first phase image and the second phase image may be generated based on phase signals generated from one pair of phase signal collectors. As a result, there may occur a difference between the first phase image and the second phase image according to a difference in position between the phase signal collectors and a path of the incident light passing through the lens 210.

If the in-focus position of the lens 210 is controlled so that the pair of phase images moves by the target parallax, the pair of phase images may coincide with each other. When the pair of phase images coincides with each other, the focus position of the lens 210 may be referred to as the in-focus position.

When each of the first phase image and the second phase image is shifted by the target parallax, a difference between the shifted first phase image and the shifted second phase image is minimized.

In this case, the target parallax may be a phase shift value that can minimize the difference between the first phase image and the second phase image.

The candidate parallax may represent a possible parallax value with a corresponding degree of certainty that it is the target parallax.

When the first phase image and the second phase image are distorted by noise, a parallax calculated as a minimum difference between the first phase image and the second phase image may be different from the target parallax.

In some implementations, the image processor 20 may calculate an evaluation value that represents the degree of the certainty that the candidate parallax is the target parallax.

The evaluation value corresponding to the candidate parallax may shift the first phase image and the second phase image by the candidate parallax. In some implementations, the evaluation value may represent a difference value between the shifted first phase image and the shifted second phase image.

In some implementations, the candidate parallax that shifts the first phase image and the second phase image so that the difference value between the first phase image and the second phase image can be minimized may have the highest certainty of being the target parallax.

In some implementations, the image processor 20 may calculate a set of evaluation values based on the sum of absolute differences (SAD) between the first phase image and the second phase image.

In some other implementations, the image processor 20 may calculate a set of evaluation values based on the sum of square differences (SSD) between the first phase image and the second phase image.

In some other implementations, the image processor 20 may calculate a set of evaluation values based on a phase correlation between the first phase image and the second phase image.

In some other implementations, the image processor 20 may calculate a set of evaluation values based on cross-correlation between the first phase image and the second phase image.

The various implementations of calculating the set of evaluation values (hereinafter referred to as the evaluation value set) are provided as examples. The disclosed technology can employ any calculation method that can determine difference values between phase images without being limited thereto.

The motion detector 30 may include a sensor that detects the movement of the imaging device 1 or the movement of the external object(S). In some implementations, the motion detector 30 may include an external sensor such as a gyroscope sensor.

In some other implementations, the motion detector 30 may receive an image from the image processor 20 and may detect the movement of the imaging device 1 or the movement of the external object(S) based on the received image.

When a movement exceeding a threshold occurs, the motion detector 30 may provide the image processor 20 with information about a phase image set corresponding to the movement exceeding the threshold.

The image processor 20 may calculate a target parallax amount based on the remaining phase image sets, excluding the phase image set corresponding to the movement exceeding the threshold, based on the information received from the motion detector 30.

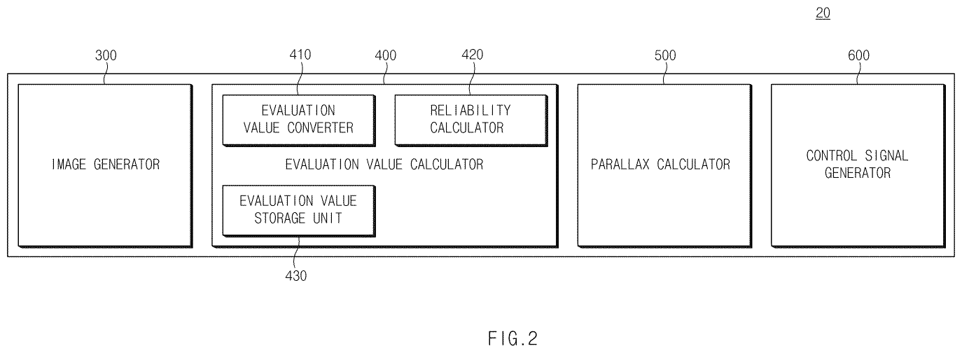

FIG. 2 is a block diagram illustrating an example of the image processor 20 based on embodiments of the disclosed technology.

Referring to FIG. 2, the image processor 20 may include an image generator 300, an evaluation value calculator 400, a parallax calculator 500, and a control signal generator 600.

The image generator 300 may generate general image data or

phase-difference image data based on signals received from the imaging circuit 10.

The image generator 300 may generate a first phase image based on first phase signals output from first phase signal collectors included in the pixel array 110 (see FIG. 1). In addition, the image generator 300 may generate a second phase image based on second phase signals output from second phase signal collectors included in the pixel array 110 (see FIG. 1).

The image generator 300 may generate a phase image set including the first phase image and the second phase image.

The image generator 300 may perform various image data processes for improving the image quality, for example, noise reduction, gain adjustment, waveform shaping, interpolation, a white balance process, a gamma process, and/or an edge sharpening process, etc.

In some implementations, the phase image set may include a phase image pair generated based on phase signal pairs output from all pairs of phase signal collectors included in the pixel array.

At this time, the respective phase images may be images corresponding to the entire region of the pixel array.

In some other implementations, the phase image set may include phase image pairs generated based on phase signal pairs that are output from some pairs of phase signal collectors included in the pixel array.

At this time, each of the respective phase images is collected at a random time and may be an image corresponding to a partial area of the pixel array.

The imaging circuit 10 may transmit phase signals generated at preset time intervals to the image generator 300. The preset time interval may be a time period during which a sufficient number of phase signals for calculating the target parallax can be collected.

The evaluation value calculator 400 may calculate an evaluation value set including evaluation values corresponding to candidate parallaxes based on the phase image set.

As described above, the evaluation value may be a value corresponding to the certainty that any candidate parallax is the target parallax.

The evaluation value calculator 400 may calculate the evaluation values through the sum of absolute differences (SAD) between the phase images, the sum of square differences (SSD) between the phase images, phase correlation between the phase images, or cross-correlation between the phase images.

The evaluation value set may include evaluation values for candidate parallaxes. The evaluation values corresponding to candidate parallaxes may be displayed in a two-dimensional (2D) plane.

The evaluation value calculator 400 may linearly interpolate the evaluation values corresponding to the candidate parallaxes, and may thus calculate evaluation values of candidate parallaxes for which evaluation values have not been calculated.

The evaluation value calculator 400 may calculate a plurality of evaluation value sets corresponding to the respective phase image sets based on the plurality of phase image sets.

In some implementations, the phase image sets may correspond to phase signal pairs collected at different times, respectively.

More specifically, the evaluation value calculator 400 may calculate evaluation value sets based on a pair of the first phase image and the second phase image corresponding to phase signals collected at different times.

At this time, the first phase image and the second phase image may be images corresponding to phase signals output from all pixels included in the pixel array.

In some other implementations, the phase image sets may correspond to phase signal pairs collected at the same time, respectively. More specifically, the first phase image and the second phase image may be images corresponding to phase signals output from some pixels of the pixel array.

The evaluation value converter 410 may convert evaluation value sets respectively corresponding to the plurality of phase image sets into evaluation value sets corresponding to a current in-focus position of the imaging circuit 10.

The phase image sets corresponding to phase signals collected at different times may be collected with different in-focus positions of the imaging circuit 10.

The evaluation value converter 410 may convert the evaluation value sets corresponding to the phase image sets collected at different in-focus positions into values corresponding to the current in-focus position, so that the evaluation value sets collected at different in-focus positions can be used to calculate the target parallax.

The evaluation value converter 410 may receive in-focus position information corresponding to each phase image set from the imaging circuit 10, and may convert the evaluation value sets to correspond to the current focal length based on the received in-focus position information.

More specifically, the evaluation value converter 410 may calibrate the candidate parallax to correspond to the current focal distance based on in-focus position information corresponding to the phase image set. Additionally, the evaluation values can be converted by interpolating the calibrated candidate parallaxes and some evaluation values corresponding to the calibrated candidate parallaxes.

The reliability calculator 420 may calculate reliability corresponding to each set of evaluation values.

In some implementations, the reliability calculator 420 may display an evaluation value corresponding to a candidate parallax on a two-dimensional (2D) plane, and may calculate the evaluation value based on the shape of the depicted candidate parallax graph.

More specifically, the reliability calculator 420 may display a graph of continuous evaluation values corresponding to the candidate parallaxes through interpolation, and may calculate reliability by comparing the graph with a curvature function fitted to the evaluation value graph.

In some other implementations, the reliability calculator 420 may calculate reliability based on the contrast between the first phase image and the second phase image.

In some other implementations, the reliability calculator 420 may calculate reliability based on a difference between a maximum value, a minimum value, and an average value of the evaluation values.

In some implementations, reliability may correspond to a set of evaluation values. The reliability may be used as a weight for each evaluation value set when calculating the target parallax.

The reliability calculator 420 may receive data for reliability calculation through the imaging circuit 10.

The evaluation value storage unit 430 may store the set of calculated evaluation values. The evaluation value set may be matched with the corresponding reliability and then stored, and the time at which the phase image sets have been collected and the in-focus position of the lens 210 may also be matched with the evaluation value set and then stored.

Additionally, the evaluation value storage unit 430 may store the target parallax calculated by the parallax calculator 500 and the phase image set that is used as a basis for target parallax calculation in response to the in-focus position of the lens 210. The evaluation value calculator 400 may reflect the previously stored target parallax and the corresponding in-focus position information in the evaluation value calculation.

The parallax calculator 500 may calculate the target parallax based on a plurality of evaluation value sets including candidate parallaxes and evaluation values.

When there is no noise, the target parallax may refer to a parallax calculated from the first phase image and the second phase image corresponding to the current in-focus position of the lens 210.

As the parallax calculator 500 calculates the target parallax based on a plurality of evaluation value sets, the influence of noise on an arbitrary phase image set may be reduced.

In some implementations, the parallax calculator 500 may calculate the sum of evaluation values corresponding to the candidate parallaxes, and may determine a candidate parallax with the largest sum of evaluation values as the target parallax.

In some other implementations, the parallax calculator 500 may calculate the target parallax by reflecting the reliability corresponding to the evaluation value set.

For example, the parallax calculator 500 may multiply the evaluation values included in the evaluation value set by the reliability, and may calculate a candidate parallax with the largest sum of the evaluation values multiplied by the reliability as the target parallax.

In some other implementations, the parallax calculator 500 may calculate the target parallax based on candidate parallaxes corresponding to the maximum evaluation values included in the respective evaluation value sets.

For example, the parallax calculator 500 may calculate a candidate parallax with the highest frequency of having the maximum evaluation value as the target parallax.

The control signal generator 600 may generate a control signal for controlling the imaging circuit 10 based on the calculated target parallax.

The control signal generated by the control signal generator 600 may be a control signal for adjusting the in-focus position of the lens 210 included in the imaging circuit 10. As the control signal is generated based on the target parallax, the in-focus position of the lens 210 is adjusted so that the first phase image and the second phase image may coincide with each other. The in-focus position of the lens 210 where the first phase image and the second phase image coincide with each other may be referred to as an “exact in-focus” position. The control signal generator 600 may transmit the generated control signal to the lens module 200. The lens module 200 may control the lens driver 220 based on the control signal, and the lens driver 220 may adjust the in-focus position of the lens 210.

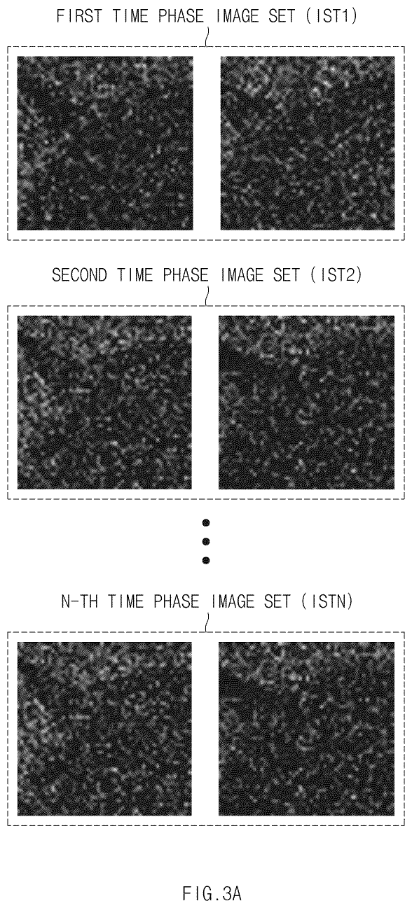

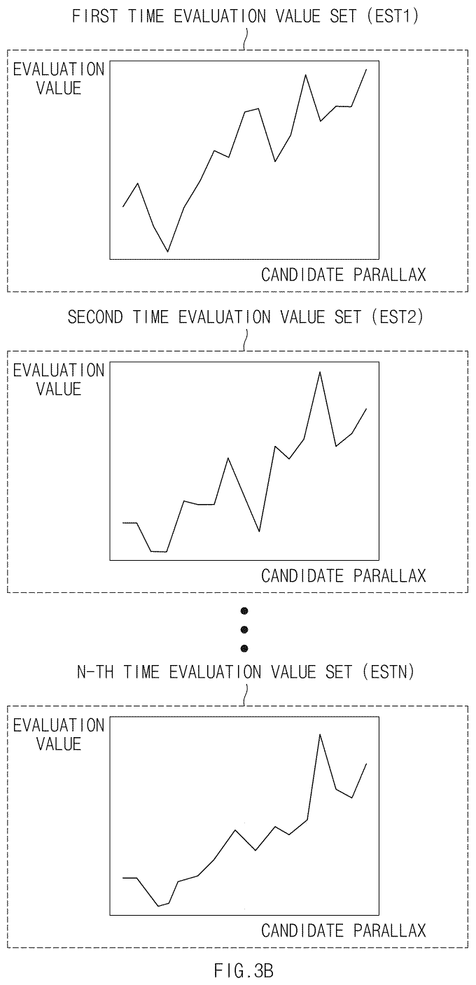

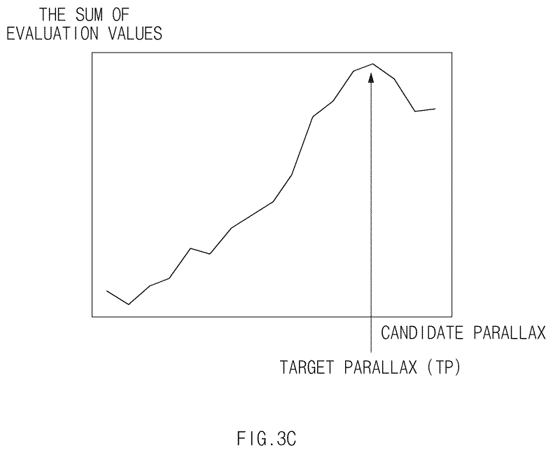

FIGS. 3A to 3C are diagrams illustrating examples of a method for calculating the target parallax based on the plurality of phase signal pairs collected at different times according to embodiments of the present disclosure.

Referring to FIG. 3A, the image generator 300 (see FIG. 2) included in the image processor 20 (see FIG. 2) may receive phase signals for each time from the imaging circuit 10, and may generate image sets (IST1, IST2, . . . and ISTN).

Multiple time phase image sets including the first time phase image set (IST1), the second time phase image set (IST2), . . . and the N-th time phase image set (ISTN) may correspond to phase signals collected at different times by the imaging circuit 10 (see FIG. 1).

The evaluation value calculator 400 (see FIG. 2) may calculate a first time evaluation value set (EST1), a second time evaluation value set (EST2), and the N-th time evaluation value set (ESTN) based on the first time phase image set (IST1), the second time phase image set (IST2), and the N-th time phase image set (ISTN).

The first time evaluation value set (EST1), the second time evaluation value set (EST2), and the N-th time evaluation value set (ESTN) may be depicted as evaluation value curves for candidate parallaxes, as shown in FIG. 3B. The set of evaluation values for the candidate parallax may be calculated based on the phase images included in each phase image set (IST1, IST2, . . . and ISTN).

For example, the evaluation value set may be calculated based on the sum of absolute differences (SAD) between the first phase image and the second phase image included in each phase image set.

More specifically, the sum of absolute differences (SAD) between the first phase image and the second phase image for each candidate parallax may be calculated, and the inverse number (reciprocal) of the calculated SAD may be used as an evaluation value.

A candidate parallax with the smallest SAD between the first phase image and the second phase image may be used as a candidate parallax with the highest certainty of being the target parallax.

The evaluation value curves shown in FIG. 3B may be linearly interpolated and shown as continuous curves. Evaluation values corresponding to the candidate parallax may be an inverse number (reciprocal) of the SAD between the first phase image and the second phase image.

As shown in FIG. 3C, the parallax calculator 500 (see FIG. 2) may calculate a target parallax (TP) based on a plurality of evaluation value sets (EST1, EST2, . . . and ESTN).

In some implementations, the parallax calculator may calculate the target parallax (TP) based on the evaluation value sets. More specifically, the parallax calculator may calculate the target parallax (TP) based on the sum of evaluation values corresponding to each candidate parallax.

Distortion caused by noise can be prevented by calculating the sum of evaluation values corresponding to each candidate parallax using a plurality of evaluation value sets.

Referring to FIG. 3C, the sum of evaluation values for each candidate parallax can be shown as a continuous curve. The parallax calculator may calculate the candidate parallax with the largest sum of evaluation values as the target parallax (TP) in the curve of the sum of evaluation values for the candidate parallaxes.

In some implementations, the evaluation value calculator may store the current in-focus position of the imaging circuit that has collected the phase signals and the target parallax (TP) calculated by the parallax calculator in correspondence with each other.

In some implementations, the imaging circuit may select phase signal pairs whose in-focus positions coincide with each other among the phase signal pairs collected at different times, and may transmit the selected phase signal pairs to the evaluation value calculator.

When the evaluation value calculator calculates an evaluation value set based on phase image sets including phase images whose in-focus positions coincide with each other, separate correction for each evaluation value set may not be performed. Additionally, the parallax calculator may calculate the target parallax (TP) based on evaluation value sets that correspond to the coinciding in-focus positions.

In some other implementations, the imaging circuit may transmit phase signal pairs with different in-focus positions among phase signals collected at different times to the evaluation value calculator. At this time, the phase signal pairs transmitted by the imaging circuit may be phase signals collected during a preset time interval.

The evaluation value calculator may calculate evaluation value sets based on phase image sets with different in-focus positions, and may convert the calculated evaluation value sets into evaluation value sets corresponding to the current in-focus position of the imaging circuit.

In some implementations, the imaging circuit may transmit phase signal pairs at preset time intervals.

When receiving a new phase image set, the evaluation value calculator may discard the evaluation value sets calculated based on the previously received phase image sets.

In some other implementations, the evaluation value calculator may calculate reliability for each evaluation value set (EST1, EST2).

When calculating the target parallax, the parallax calculator may reflect the reliability of each evaluation value set (EST1, EST2). For example, the reliability can be multiplied by each evaluation value set (EST1, EST2) to obtain the sum of evaluation values for the candidate parallax. In the example, the parallax calculator may use reliability as a weight for calculating the target parallax (TP).

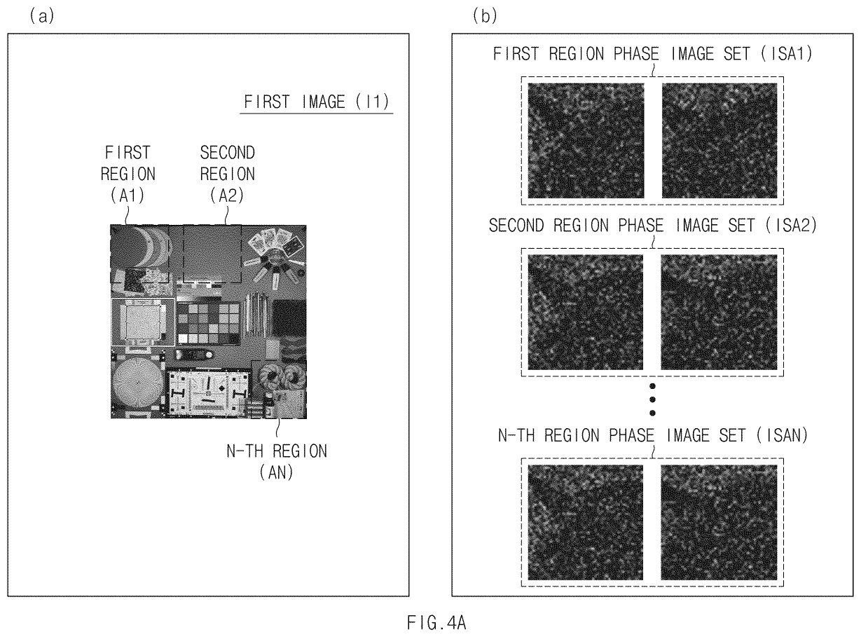

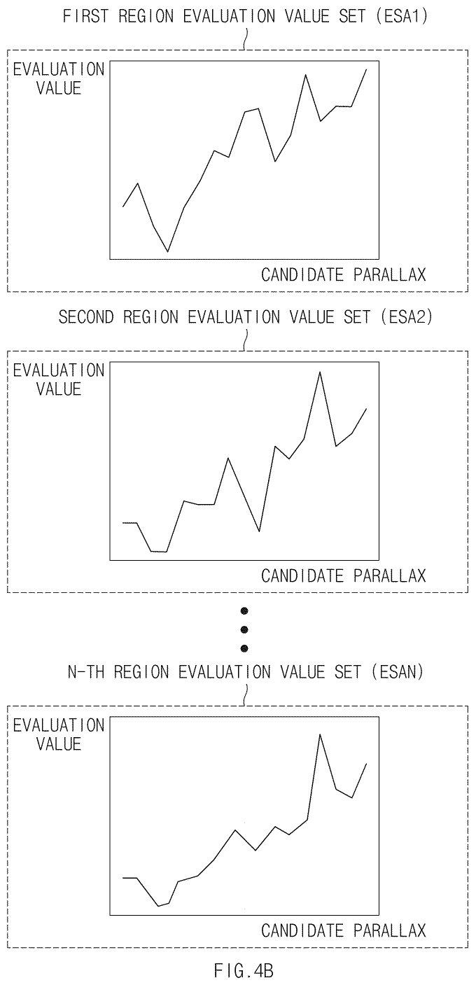

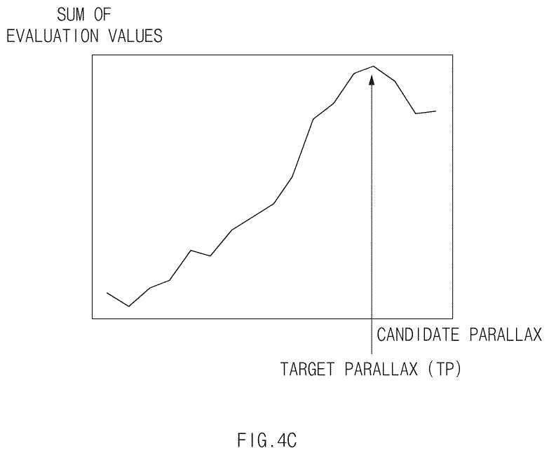

FIGS. 4A to 4C are diagrams illustrating examples of a method for calculating the target parallax (TP) based on a single image collected at an arbitrary time according to embodiments of the present disclosure.

As illustrated in (a) of FIG. 4A, a first image (I1) captured by the imaging circuit 10 (see FIG. 1) may be divided into a plurality of regions (A1, A2 to AN). The first image (I1) may be an image collected through the imaging circuit at any time.

The first image (I1) may include the first region (A1), the second region (A2), . . . , and the N-th region (AN), which correspond to different regions of the first image (I1).

The image generator 300 (see FIG. 2) may receive a phase signal for each region from the imaging circuit 10 and may generate image sets (ISA1, ISA2, . . . and ISAN).

A first region phase image set (ISA1), a second region phase image set (ISA2), . . . and the N-th region phase image set (ISAN) may correspond to different regions of the first image (I1), respectively.

The image generator may transmit the generated phase image sets (ISA1, ISA2, . . . and ISAN) to the evaluation value calculator 400 (see FIG. 2).

Noise for each region of the first image (I1) may vary depending on the physical structure of the imaging circuit 10, the arrangement shape of unit pixels included in the pixel array 110, etc.

The first region phase image set (ISA1) and the second region phase image set (ISA2) may be image sets collected at the same in-focus position at the same time.

The evaluation value calculator may calculate region evaluation value sets including the first region evaluation value set (ESA1), the second region evaluation value set (ESA2), . . . and the N-th region evaluation value set (ESAN) based on the received region phase image sets including the received first region phase image set (ISA1), the received second region phase image set (ISAN2), . . . , and the received N-th region phase image set (ISAN).

The region evaluation value sets including the first region evaluation value set (ESA1), the second region evaluation value set (ESA2), . . . and the N-th region evaluation value set (ESAN) may be shown as evaluation value curves for candidate parallaxes, as shown in FIG. 4B. The set of evaluation values for candidate parallaxes may be calculated based on phase images included in each image set (ISA1, ISA2, . . . and ISAN). The method for calculating the evaluation value set has already been described with reference to FIGS. 3A to 3C, and as such redundant description thereof will herein be omitted for brevity.

The evaluation value curves shown in FIG. 4B may be linearly interpolated and shown as continuous curves. The evaluation values corresponding to the candidate parallax may be an inverse number (reciprocal) of the sum of absolute differences (SAD) between the first phase image and the second phase image included in each image set (ISA1, ISA2, . . . and ISAN).

As shown in FIG. 4C, the parallax calculator 500 (see FIG. 2) may calculate the target parallax (TP) based on a plurality of evaluation value sets (ESA1, ESA2, . . . and ESAN).

In some implementations, the parallax calculator may calculate the target parallax (TP) based on evaluation value sets. The target parallax (TP) calculation method has already been described with reference to FIGS. 3A to 3C, and as such redundant description thereof will herein be omitted for brevity.

The sum of evaluation values corresponding to each candidate parallax may be calculated using the plurality of evaluation value sets that are included in one image (I1) and correspond to different regions (A1, A2, . . . and AN), so that distortion caused by noise can be prevented.

The first region phase image set (ISA1), the second region phase image set (ISA2), . . . and the N-th region phase image set (ISAN) are phase image sets including phase images in which the in-focus positions of the lenses coincide with each other, such that separate correction for each of the evaluation value sets may not be necessary.

In some implementations, the imaging circuit 10 may collect phase signals at preset time intervals and may transmit the collected phase signals to the image generator.

When the evaluation value calculator receives a new phase image set from the image generator, the evaluation value sets calculated based on the previously received phase image sets may be discarded.

In some other implementations, the evaluation value calculator may calculate reliability for each evaluation value set (ESA1, ESA2, . . . and ESAN).

When calculating the target parallax (TP), the parallax calculator may reflect the reliability of each evaluation value set (ESA1, ESA2 to ESAN) in the TP calculation process.

As is apparent from the above description, the imaging device based on some implementations of the present disclosure may include an image processor that can more accurately calculate a target parallax by reducing the influence of noise.

The image processor based on some implementations of the present disclosure may calculate an evaluation-value set including evaluation values for each of candidate parallaxes expected to be the target parallax, and may calculate the target parallax based on the calculated evaluation-value set.

The embodiments of the present disclosure may provide a variety of effects capable of being directly or indirectly recognized through the above-mentioned patent document.

Those skilled in the art will appreciate that the present disclosure may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in this patent document.

What is claimed is:

1. An imaging device comprising:
an evaluation value calculator configured to calculate an evaluation value set including evaluation values corresponding to candidate parallaxes based on a phase image set; and
a parallax calculator configured to calculate a target parallax based on the evaluation value set, the target parallax representing a phase shift value that allows to minimize a difference between phase images corresponding to phase signals with respect to an object to be imaged;
wherein
each of the evaluation values indicates a degree of certainty that the candidate parallax corresponding to each evaluation value is the target parallax.

2. The imaging device according to claim 1, further comprising:
an imaging circuit that includes a lens and is configured to collect a phase signal pair including a first phase signal for the object and a second phase signal for the object,
wherein
the phase image set includes a first phase image corresponding to the first phase signal and a second phase image corresponding to the second phase signal.

3. The imaging device according to claim 2, wherein:
the target parallax controls an in-focus position of the lens so that the first phase image and the second phase image coincide with each other.

4. The imaging device according to claim 2, wherein the evaluation value calculator is configured to:
calculate the evaluation value set based on a sum of absolute differences (SAD) between the first phase image and the second phase image.

5. The imaging device according to claim 2, wherein the evaluation value calculator is configured to:
calculate the evaluation value set based on a sum of square differences (SSD) between the first phase image and the second phase image.

6. The imaging device according to claim 2, wherein the evaluation value calculator is configured to:
calculate the evaluation value set based on a phase correlation between the first phase image and the second phase image.

7. The imaging device according to claim 2, wherein the evaluation value calculator is configured to:
calculate the evaluation value set based on a cross-correlation between the first phase image and the second phase image.

8. The imaging device according to claim 2, further comprising:
an image generator configured to generate the phase image set based on the phase signal pair.

9. The imaging device according to claim 8, wherein:
the image generator is configured to generate a plurality of time phase image sets based on a plurality of phase signal pairs collected at different times;
the evaluation value calculator is further configured to calculate a plurality of time evaluation value sets respectively corresponding to the plurality of time phase image sets; and
the parallax calculator is further configured to calculate the target parallax based on the plurality of time evaluation value sets.

10. The imaging device according to claim 8, wherein:
the image generator is further configured to generate a plurality of region phase image sets based on one phase signal pair collected at an arbitrary time;
the evaluation value calculator is further configured to calculate a plurality of region evaluation value sets corresponding to the plurality of region phase image sets; and
the parallax calculator is configured to calculate the target parallax based on the plurality of region evaluation value sets.

11. The imaging device according to claim 8, wherein:
the imaging circuit is configured to transmit the phase signal pair to the image generator at preset time intervals; and
the image generator is configured to generate the phase image set at the preset time intervals.

12. The imaging device according to claim 11, wherein:
upon receiving new phase image sets, the evaluation value calculator is further configured to discard evaluation value sets calculated based on previously received phase image sets.

13. The imaging device according to claim 1, wherein the parallax calculator is further configured to:
calculate a sum of evaluation values that are respectively included in different evaluation value sets and correspond to an arbitrary candidate parallax; and
calculate a candidate parallax with the largest sum of evaluation values as the target parallax.

14. The imaging device according to claim 1, wherein:
the evaluation value calculator is further configured to convert a plurality of evaluation value sets corresponding to a plurality of phase image sets into evaluation value sets corresponding to a current in-focus position of a lens included in the imaging device; and
the parallax calculator is further configured to calculate the target parallax based on evaluation value sets corresponding to the current in-focus position of the lens.

15. The imaging device according to claim 1, wherein:
the evaluation value calculator is further configured to calculate reliability for the evaluation value set based on noise of the phase image set; and
the parallax calculator is configured to calculate the target parallax based on the reliability.

16. The imaging device according to claim 1, wherein:
the parallax calculator is configured to calculate the target parallax based on candidate parallaxes respectively corresponding to maximum evaluation values included in different evaluation value sets.

17. An imaging device comprising:
an imaging circuit including a lens and configured to collect a plurality of phase signal pairs for an object;
an image generator configured to generate a plurality of phase image sets based on the plurality of phase signal pairs;
an evaluation value calculator configured to calculate a plurality of evaluation value sets including evaluation values corresponding to candidate parallaxes, based on the plurality of phase image sets; and
a parallax calculator configured to calculate a target parallax based on the plurality of evaluation value sets, the target parallax representing a phase shift value that allows to minimize a difference between phase images corresponding to the plurality of phase signal pairs;
wherein
the target parallax is a parallax that controls an in-focus position of the lens with respect to the object.

18. The imaging device according to claim 17, wherein:
each of the evaluation values indicate a degree of certainty that the candidate parallax corresponding to each evaluation value is the target parallax.

19. The imaging device according to claim 17, wherein:
the plurality of phase signal pairs is collected at different times.

20. The imaging device according to claim 17, wherein:
the plurality of phase signal pairs is collected at a same time.
